(19) United States
(12) Patent Application Publication
(10) Pub. No.: US 2017/0033458 A1
(43) Pub. Date: Feb. 2, 2017

(54) Multi-Beam Antenna System

(71) Applicant: Google Inc., Mountain View, CA (US)

(72) Inventor: Dedi David Haziza, Sunnyvale, CA (US)

(73) Assignee: Google Inc., Mountain View, CA (US)

(21) Appl. No.: 14/810,761

(22) Filed: Jul. 28, 2015

(51) Int. Cl. H01Q 3/34; H04B 7/185; H01Q 21/06

(52) U.S. Cl. CPC H01Q 3/34; H01Q 21/06; H04B 7/18506

(57) ABSTRACT

An antenna array includes a first antenna disposed on a micro strip and oriented along a first axis in a first direction, a second antenna disposed on the micro strip and oriented along a second axis in the first direction, a third antenna disposed on the micro strip and oriented along the first axis in a second direction opposite the first direction and a fourth antenna disposed on the micro strip and oriented along the second axis in the second direction. The antenna array further includes a phase shifter connected to at least one of the antennas.

### TECHNICAL FIELD

This disclosure relates to a multi-beam antenna system.

### BACKGROUND

A communication network is a large distributed system for receiving information (signal) and transmitting the information to a destination. Over the past few decades the demand for communication access has dramatically increased. Although conventional wire and fiber landlines, cellular networks, and geostationary satellite systems have continuously been increasing to accommodate the growth in demand, the existing communication infrastructure is still not large enough to accommodate the increase in demand. In addition, some areas of the world are not connected to a communication network and therefore cannot be part of the global community where everything is connected to the internet.

Satellites are used to provide communication services to areas where wired cables cannot reach. Satellites may be geostationary or non-geostationary. Geostationary satellites remain permanently in the same area of the sky as viewed from a specific location on earth, because the satellite is orbiting the equator with an orbital period of exactly one day. Non-geostationary satellites typically operate in low- or mid-earth orbit, and do not remain stationary relative to a fixed point on earth; the orbital path of a satellite can be described in part by the plane intersecting the center of the earth and containing the orbit. Each satellite may be equipped with communication devices called inter-satellite links (or, more generally, inter-device links) to communicate with other satellites in the same plane or in other planes. The communication devices allow the satellites to communicate with other satellites. These communication devices are expensive and heavy. In addition, the communication devices significantly increase the cost of building, launching and operating each satellite; they also greatly complicate the design and development of the satellite communication system and associated antennas and mechanisms to allow each satellite to acquire and track other satellites whose relative position is changing. Each antenna has a mechanical or electronic steering mechanism, which adds weight, cost, vibration, and complexity to the satellite, and increases risk of failure. Requirements for such tracking mechanisms are much more challenging for inter-satellite links designed to communicate with satellites in different planes than for links, which only communicate with nearby satellites in the same plane, since there is much less variation in relative position. Similar considerations and added cost apply to high-altitude communication balloon systems with inter-balloon links.

### SUMMARY

One aspect of the disclosure provides an antenna array. The antenna array includes a first antenna disposed on a micro strip and oriented along a first axis in a first direction, a second antenna disposed on the micro strip and oriented along a second axis in the first direction, a third antenna disposed on the micro strip and oriented along the first axis in a second direction opposite the first direction and a fourth antenna disposed on the micro strip and oriented along the second axis in the second direction. The antenna array further includes a phase shifter connected to at least one of the antennas.

Implementations of the disclosure may include one or more of the following optional features. The orientation of each antenna may indicate and/or correspond to a beam orientation of the antenna or an orientation of a beam forming pattern thereof. Moreover, the orientation of the antenna may be used for steering a corresponding emission beam or as a reference direction for steering the corresponding emission beam. In some implementations, the antenna array includes a first feed line connected to the first antenna oriented on the first axis in the first direction and a second feed line connected to the second antenna oriented on the second axis in the first direction. The antenna array may further include a third feed line connected to the third antenna oriented on the first axis in the second direction and a fourth feed line connected to the fourth antenna oriented on the second axis in the second direction. The antenna array may include a first array feed line connected to the first feed line and the second feed line, and a second array feed line connected to the third feed line and the fourth feed line.

In some examples, the first antenna, the second antenna, the third antenna, and the fourth antenna transmit a steerable beam. The antenna array may include a butler matrix connected to the first antenna, the second antenna, the third antenna, and the fourth antenna. The steerable beam may be steerable by varying a power to the first feed line and the second array feed line. The butler matrix may be connected to the phase shifter to provide a beam forming network.

The antenna array may further include a first input port connected to the first feed line and a second input port connected to the second feed line. The antenna array may further include a first signal length related to the distance the signal must travel from the first input port to the first antenna and a second signal length related to the distance the signal must travel from the second input port to the third antenna. The first signal length and the second signal length may be different lengths. The beam may be steerable by adjusting the phase shifter to steer the steerable beam, wherein the steerable beam transmits and/or receives data.

Another aspect of the disclosure provides a communication system. The communication system may include an unmanned aerial system, at least one antenna array disposed on the unmanned aerial system and a ground station configured to communicate with the at least one antenna array. The at least one antenna array includes a first antenna disposed on a micro strip and configured to transmit a first signal, a second antenna disposed on the micro strip and configured to transmit a second signal, a third antenna disposed on the micro strip and configured to transmit a third signal, and a fourth antenna disposed on the micro strip and configured to transmit a fourth signal. The antenna array further includes a phase shifter connected to at least one of the antennas, wherein the first signal, second signal, third signal, and fourth signal combine to form a steerable beam.

This aspect may include one or more of the following optional features. In some examples, the unmanned aerial system steers the steerable beam based on a position of the unmanned aerial system in relation to the ground station. At least one antenna array may include a first antenna array having a first steerable beam, and a second antenna array having a second steerable beam, wherein the second steerable beam combines with the first steerable beam to form a third steerable beam. The second steerable beam combines with the first steerable beam to form the third steerable beam in response to a data volume being communicated by the ground station. The second steerable beam may further combine with the first steerable beam to form the third steerable beam in response to a signal strength received by the first antenna array and the second antenna array. In some implementations, the third steerable beam communicates to the ground station. The second steerable beam communicates data to a first ground station and the third steerable beam communicates data to a second ground station. The second steerable beam may further communicate data to a user device.

In some examples, the first antenna is disposed on a micro strip and oriented along a first axis in a first direction and the second antenna is disposed on the micro strip and oriented along a second axis in the first direction. The third antenna is disposed on the micro strip and oriented along the first axis in a second direction opposite the first direction and the fourth antenna is disposed on the micro strip and oriented along the second axis in the second direction. The orientation of each antenna may indicate and/or correspond to a beam orientation of the antenna or an orientation of a beam forming pattern thereof. Moreover, the orientation of the antenna may be used for steering a corresponding emission beam or as a reference direction for steering the corresponding emission beam. The antenna array may further include a first feed line connected to the first antenna oriented on the first axis in the first direction and a second feed line connected to the second antenna oriented on the second axis in the first direction. The antenna array may further include a third feed line connected to the third antenna oriented on the first axis in the second direction and a fourth feed line connected to the fourth antenna oriented on the second axis in the second direction. The antenna array may also include a first array feed line connected to the first feed line and the second feed line, and a second array feed line connected to the third feed line and the fourth feed line.

The details of one or more implementations of the disclosure are set forth in the accompanying drawings and the description below. Other aspects, features, and advantages will be apparent from the description and drawings, and from the claims.

### DESCRIPTION OF DRAWINGS

FIG. 1A is a schematic view of an exemplary communication system.

FIG. 1B is a schematic view of an exemplary global-scale communication system with satellites and communication balloons, where the satellites form a polar constellation.

FIG. 1C is a schematic view of an exemplary group of satellites of FIG. 1A forming a Walker constellation.

FIGS. 2A and 2B are perspective views of example high-altitude platforms.

FIG. 3 is a perspective view of an example satellite.

FIG. 4A is a schematic view of an exemplary communication system that includes a high altitude platform and a ground terminal.

FIG. 4B is a schematic view of an exemplary communication system that includes a phased antenna array and end users.

FIG. 5A is a top view of an exemplary phased antenna array.

FIG. 5B is a schematic view of an exemplary phased antenna array including a butler matrix.

FIG. 5C is a schematic view of an exemplary phased antenna array including a phase shifter.

FIG. 5D is a schematic view of an exemplary phased antenna array including a butler matrix and a phase shifter.

FIG. 6 is a schematic view of multiple exemplary phased antenna arrays.

Like reference symbols in the various drawings indicate like elements.

### DETAILED DESCRIPTION

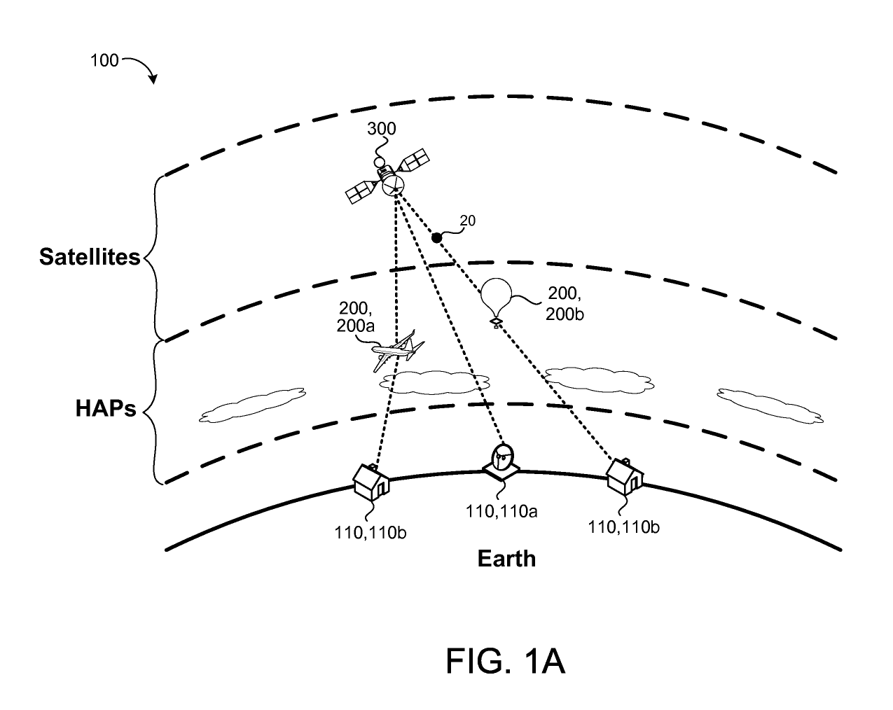

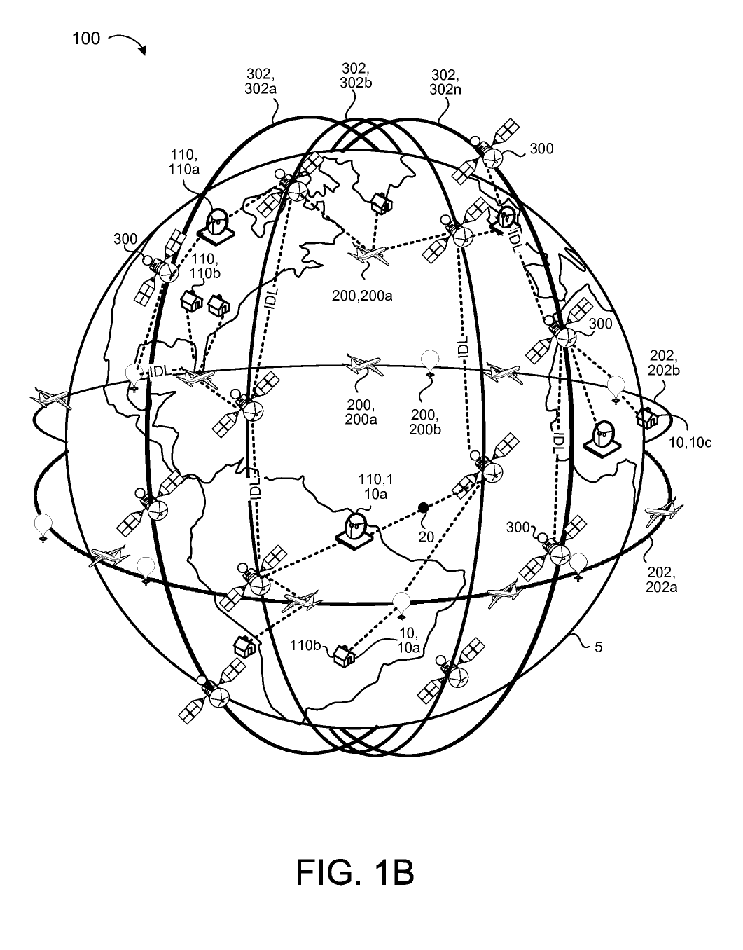

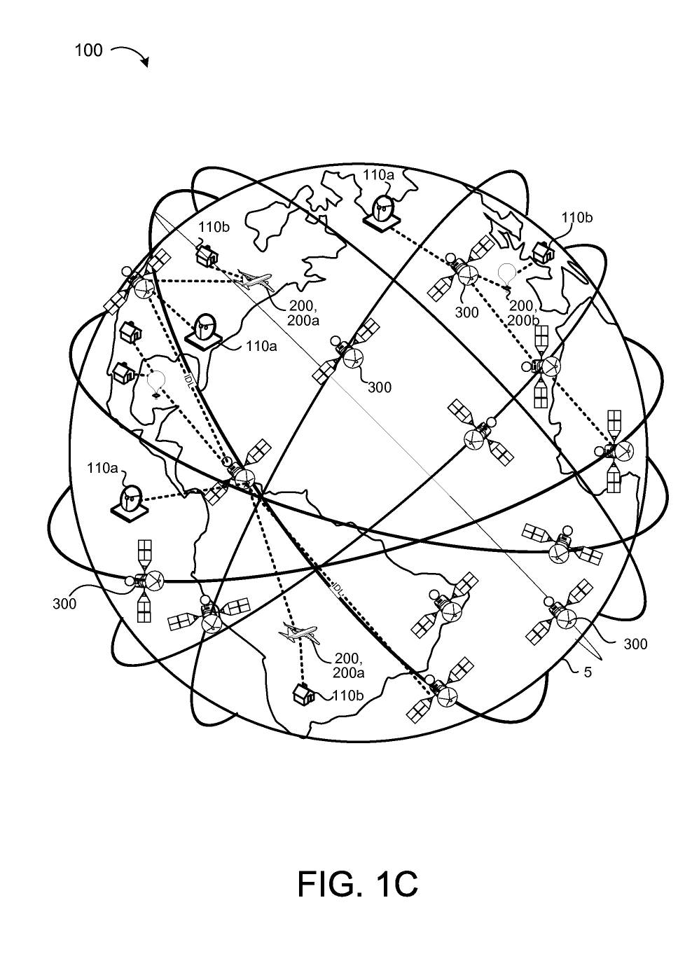

Referring to FIGS. 1A-1C, in some implementations, a global-scale communication system 100 includes gateways 110 (e.g., source ground stations 110a and destination ground stations 110b), high altitude platforms (HAPs) 200, and satellites 300. The source ground stations 110a may communicate with the satellites 300, the satellites 300 may communicate with the HAPs 200, and the HAPs 200 may communicate with the destination ground stations 110b. In some examples, the source ground stations 110a also operate as linking-gateways between satellites 300. The source ground stations 110a may be connected to one or more service providers and the destination ground stations 110b may be user terminals (e.g., mobile devices, residential WiFi devices, home networks, etc.). In some implementations, a HAP 200 is an aerial communication device that operates at high altitudes (e.g., 17-22 km). The HAP may be released into the earth's atmosphere, e.g., by an air craft, or flown to the desired height. Moreover, the HAP 200 may operate as a quasi-stationary aircraft. In some examples, the HAP 200 is an aircraft 200a, such as an unmanned aerial vehicle (UAV); while in other examples, the HAP 200 is a communication balloon 200b. The satellite 300 may be in Low Earth Orbit (LEO), Medium Earth Orbit (MEO), or High Earth Orbit (HEO), including Geosynchronous Earth Orbit (GEO).

The HAPs 200 may move about the earth 5 along a path, trajectory, or orbit 202 (also referred to as a plane, since their orbit or trajectory may approximately form a geometric plane). Moreover, several HAPs 200 may operate in the same or different orbits 202. For example, some HAPs 200 may move approximately along a latitude of the earth 5 (or in a trajectory determined in part by prevailing winds) in a first orbit 202a, while other HAPs 200 may move along a different latitude or trajectory in a second orbit 202b. The HAPs 200 may be grouped amongst several different orbits 202 about the earth 5 and/or they may move along other paths 202 (e.g., individual paths). Similarly, the satellites 300 may move along different orbits 302, 302a-n. Multiple satellites 300 working in concert form a satellite constellation. The satellites 300 within the satellite constellation may operate in a coordinated fashion to overlap in ground coverage. In the example shown in FIG. 1B, the satellites 300 operate in a polar constellation by having the satellites 300 orbit the poles of the earth 5; whereas, in the example shown in FIG. 1C, the satellites 300 operate in a Walker constellation, which covers areas below certain latitudes and provides a larger number of satellites 300 simultaneously in view of a gateway 110 on the ground (leading to higher availability, fewer dropped connections).

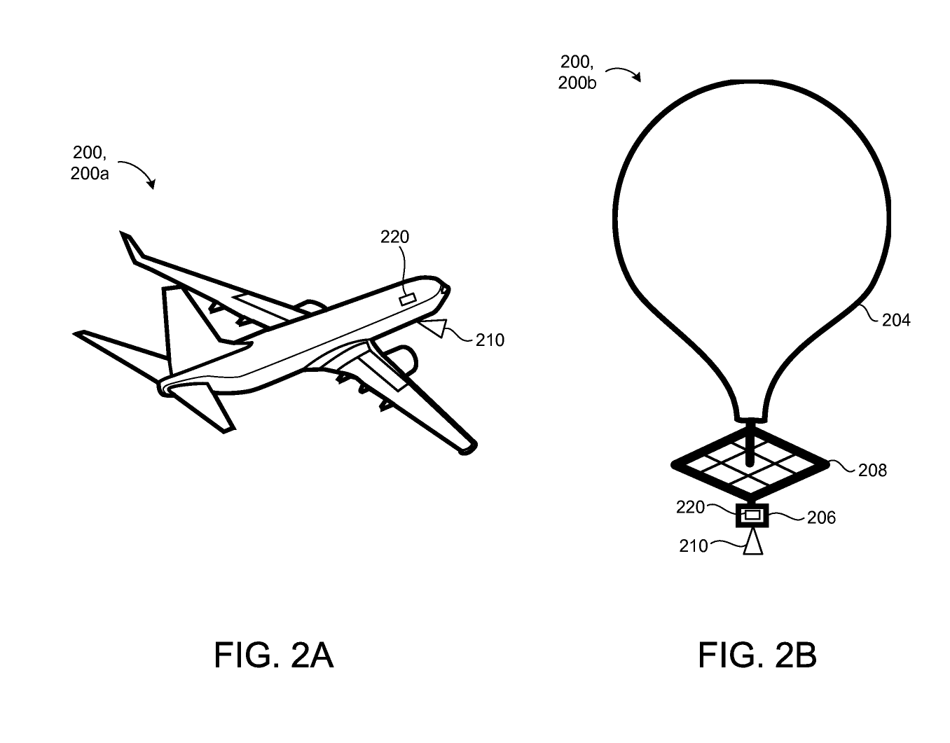

Referring to FIGS. 2A and 2B, in some implementations, the HAP 200 includes an antenna 510 that receives a communication 20 from a satellite 300 and reroutes the communication 20 to a destination ground station 110b and vice versa. The HAP 200 may include a data processing device 220 that processes the received communication 20 and determines a path of the communication 20 to arrive at the destination ground station 110b (e.g., user terminal). In some implementations, user terminals 110b on the ground have specialized antennas that send communication signals to the HAPs 200. The HAP 200 receiving the communication 20 sends the communication 20 to another HAP 200, to a satellite 300, or to a gateway 110 (e.g., a user terminal 110b).

FIG. 2B illustrates an example communication balloon 200b that includes a balloon 204 (e.g., sized about 49 feet in width and 39 feet in height and filled with helium or hydrogen), an equipment box 206, and solar panels 208. The equipment box 206a includes a data processing device 310 that executes algorithms to determine where the high-altitude balloon 200a needs to go, then each high-altitude balloon 200b moves into a layer of wind blowing in a direction that will take it where it should be going. The equipment box 206 also includes batteries to store power and a transceiver (e.g., antennas 510) to communicate with other devices (e.g., other HAPs 200, satellites 300, gateways 110, such as user terminals 110b, internet antennas on the ground, etc.). The solar panels 208 may power the equipment box 206.

Communication balloons 200a are typically released in to the earth's stratosphere to attain an altitude between 11 to 23 miles and provide connectivity for a ground area of 25 miles in diameter at speeds comparable to terrestrial wireless data services (such as, 3G or 4G). The communication balloons 200a float in the stratosphere at an altitude twice as high as airplanes and the weather (e.g., 20 km above the earth's surface). The high-altitude balloons 200a are carried around the earth 5 by winds and can be steered by rising or descending to an altitude with winds moving in the desired direction. Winds in the stratosphere are usually steady and move slowly at about 5 and 20 mph, and each layer of wind varies in direction and magnitude.

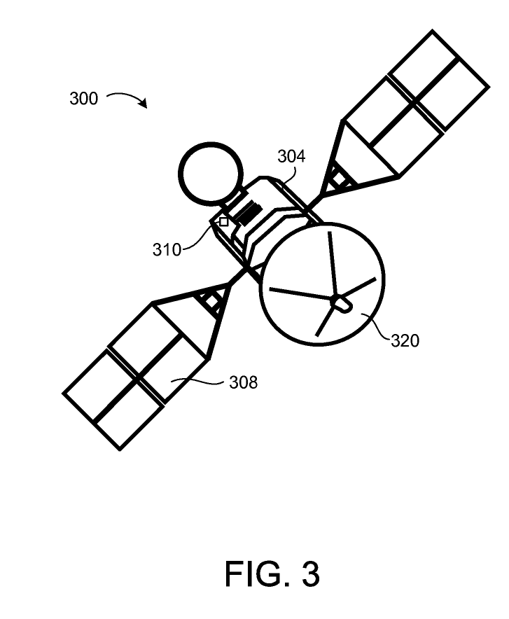

Referring to FIG. 3, a satellite 300 is an object placed into orbit 302 around the earth 5 and may serve different purposes, such as military or civilian observation satellites, communication satellites, navigations satellites, weather satellites, and research satellites. The orbit 302 of the satellite 300 varies depending in part on the purpose of the satellite 200b. Satellite orbits 302 may be classified based on their altitude from the surface of the earth 5 as Low Earth Orbit (LEO), Medium Earth Orbit (MEO), and High Earth Orbit (HEO). LEO is a geocentric orbit (i.e., orbiting around the earth 5) that ranges in altitude from 0 to 1,240 miles. MEO is also a geocentric orbit that ranges in altitude from 1,200 mile to 22,236 miles. HEO is also a geocentric orbit and has an altitude above 22,236 miles. Geosynchronous Earth Orbit (GEO) is a special case of HEO. Geostationary Earth Orbit (GSO, although sometimes also called GEO) is a special case of Geosynchronous Earth Orbit.

In some implementations, a satellite 300 includes a satellite body 304 having a data processing device 310, e.g., similar to the data processing device 310 of the HAPs 200. The data processing device 310 executes algorithms to determine where the satellite 300 is heading. The satellite 300 also includes an antenna 320 for receiving and transmitting a communication 20. The satellite 300 includes solar panels 308 mounted on the satellite body 204 for providing power to the satellite 300. In some examples, the satellite 300 includes rechargeable batteries used when sunlight is not reaching and charging the solar panels 308.

When constructing a global-scale communications system 100 using HAPs 200, it is sometimes desirable to route traffic over long distances system 100 by linking HAPs 200 to satellites 300 and/or one HAP 200 to another. For example, two satellites 300 may communicate via inter-device links and two HAPs 200 may communicate via inter-device links. Inter-device link (IDL) eliminates or reduces the number of HAPs 200 or satellites 300 to gateway 110 hops, which decreases the latency and increases the overall network capabilities. Inter-device links allow for communication traffic from one HAP 200 or satellite 300 covering a particular region to be seamlessly handed over to another HAP 200 or satellite 300 covering the same region, where a first HAP 200 or satellite 300 is leaving the first area and a second HAP 200 or satellite 300 is entering the area. Such inter-device linking IDL is useful to provide communication services to areas far from source and destination ground stations 110a, 110b and may also reduce latency and enhance security (fiber optic cables 12 may be intercepted and data going through the cable may be retrieved). This type of inter-device communication is different than the “bent-pipe” model, in which all the signal traffic goes from a source ground station 110a to a satellite 300, and then directly down to a to destination ground station 110b (e.g., user terminal) or vice versa. The “bent-pipe” model does not include any inter-device communications. Instead, the satellite 300 acts as a repeater. In some examples of “bent-pipe” models, the signal received by the satellite 300 is amplified before it is retransmitted; however, no signal processing occurs. In other examples of the “bent-pipe” model, part or all of the signal may be processed and decoded to allow for one or more of routing to different beams, error correction, or quality-of-service control; however no inter-device communication occurs.

In some implementations, large-scale communication constellations are described in terms of a number of orbits 202, 302, and the number of HAPs 200 or satellites 300 per orbit 202, 302. HAPs 200 or satellites 300 within the same orbit 202, 302 maintain the same position relative to their intra-orbit HAP 200 or satellite 300 neighbors. However, the position of a HAP 200 or a satellite 300 relative to neighbors in an adjacent orbit 202, 302 may vary over time. For example, in a large-scale satellite constellation with near-polar orbits, satellites 300 within the same orbit 202 (which corresponds roughly to a specific latitude, at a given point in time) maintain a roughly constant position relative to their intra-orbit neighbors (i.e., a forward and a rearward satellite 300), but their position relative to neighbors in an adjacent orbit 302 varies over time. A similar concept applies to the HAPs 200; however, the HAPs 200 move about the earth 5 along a latitudinal plane and maintain roughly a constant position to a neighboring HAP 200.

A source ground station 110a may be used as a connector between satellites 300 and the internet, or between HAPs 200 and user terminals 110b. In some examples, the system 100 utilizes the source ground station 110a as linking-gateways 110a for relaying a communication 20 from one HAP 200 or satellite 300 to another HAP 200 or satellite 300, where each HAP 200 or satellite 300 is in a different orbit 202, 302. For example, the linking-gateway 110a may receive a communication 20 from an orbiting satellite 300, process the communication 20, and switch the communication 20 to another satellite 300 in a different orbit 302. Therefore, the combination of the satellites 300 and the linking-gateways 110a provide a fully-connected system 100. For the purposes of further examples, the gateways 110 (e.g., source ground stations 110a and destination ground stations 110b), shall be referred to as ground stations 110.

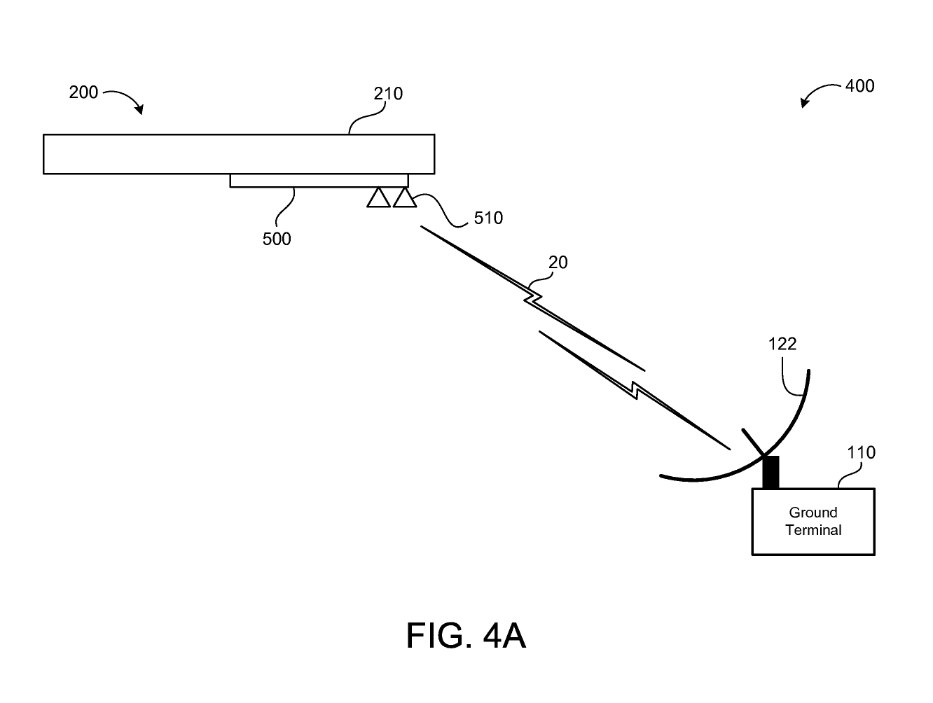

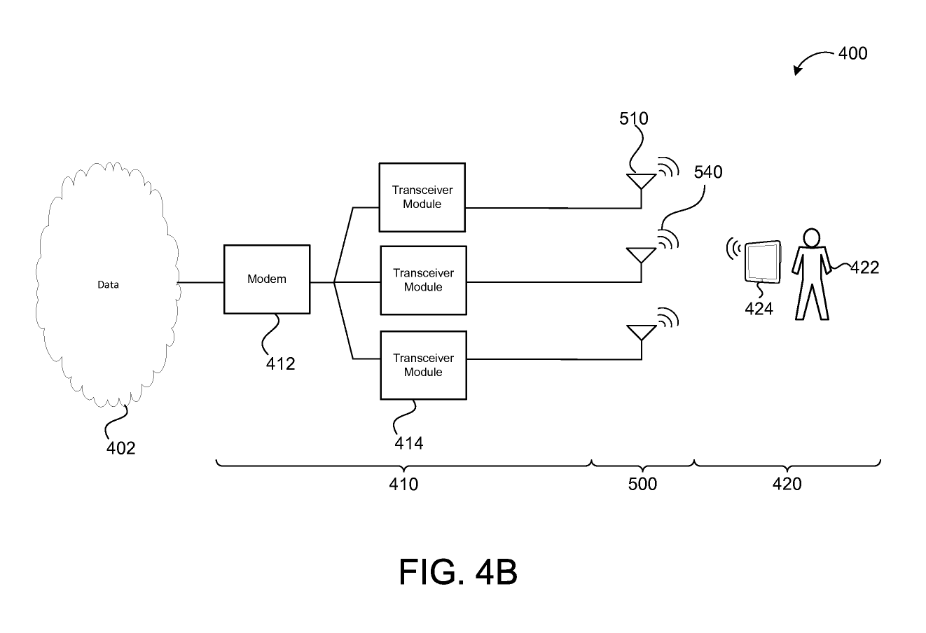

FIG. 4A provides a schematic view of an exemplary architecture of a communication system 400 establishing a communications link between a HAP 200 and a ground station 110 (e.g., a gateway 110). In some examples, the HAP 200 is an unmanned aerial system (UAS). The two terms are used interchangeably throughout this application. In the example shown, the HAP 200 includes a body 210 that supports an antenna array 500, which can communicate with the ground station 110 through a communication 20 (e.g., radio signals or electromagnetic energy). The ground station 110 includes a ground antenna 122 designed to communicate with the HAP 200. The HAP 200 may communicate various data and information to the ground station 110, such as, but not limited to, airspeed, heading, attitude position, temperature, GPS (global positioning system) coordinates, wind conditions, flight plan information, fuel quantity, battery quantity, data received from other sources, data received from other antennas, sensor data, etc. The ground station 110 may communicate to the HAP 200 various data and information, such as, but not limited to, flight directions, flight condition warnings, control inputs, requests for information, requests for sensor data, data to be retransmitted via other antennas or systems, etc. The HAP 200 may be various implementations of flying craft including a combination of the following such as, but not limited to an airplane, airship, helicopter, gyrocopter, blimp, multi-copter, glider, balloon, fixed wing, rotary wing, rotor aircraft, lifting body, heavier than air craft, lighter than air craft, etc.

One of the challenges associated with establishing a communication system between a HAP 200 and ground station 110 is the movement of the HAP 200. One solution to this problem is the use of an omnidirectional antenna system on the HAP 200 and ground station 110. This presents disadvantages as an omnidirectional antenna has a lower gain and therefore range in exchange for its ability to receive from all directions. A directional antenna may be used to improve the gain and range of the system, but this presents its own challenges as depending on how directional the antenna is, the craft may move out of the antennas transmission or reception area. When using a directional antenna, a system needs to move both of the antennas (i.e., the HAP antenna and the ground terminal antenna) to keep the antennas aligned between the aircraft and the ground. This becomes more challenging with greater directionality of the antenna. Additionally, various conditions may cause the HAP 200 to unintentionally move location, such as, but not limited to, wind, thermals, other craft, turbulence, etc., making the system moving the antenna forced to rapidly correct if continuous communication is required. A highly directional antenna may create a narrow cone transmission shape requiring the antenna to be moved on two axes to maintain alignment. This disclosure presents an antenna array 600 having a steerable beam that allows for continuous coverage of a link to a fixed ground station 110.

In radio transmission systems, an array of antennas can be used to increase the ability to communicate at greater range and/or increase antenna gain in a direction over individual elements. In a phased array antenna, the phase of individual elements may be adjusted to shape the area of coverage resulting in longer transmissions or steering the transmission direction without physically moving the array. The shape of the coverage may be adjusted by the alteration of individual elements transmission phase and gain in the array.

FIG. 4B provides a schematic view of an exemplary architecture of a communication system 400 including an antenna array 500 establishing a communications link between a HAP 200 and end users 420. Data 402 is transmitted to the controller 410, which converts the various data 402 into a form suitable to be transmitted to the antenna array 500. Contained within the controller 410 is a modem 412 and a transceiver module 414. The modem 412 converts data 402 to a signal for the transceiver module 414 to be transmitted via electromagnetic energy or radio signals. The electromagnetic energy is then transmitted or received via an antenna array 500 composed of a plurality of antennas 510. The combination of the antenna's 510 signal forms an emission beam 540. The data 402 in the form of electromagnetic energy is transmitted over the air to be received by end users 420. The end users 420 may include independent devices 424 or personal devices 422. The system can also operate in the reverse order with the end users 420 transmitting to the antenna array 500, which is then converted to data by the controller 410.

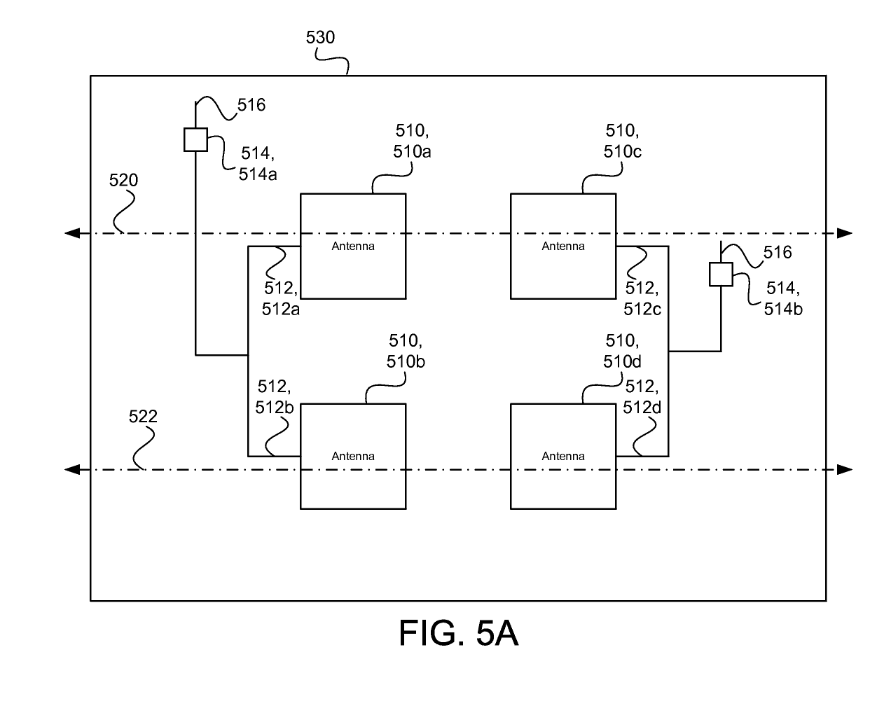

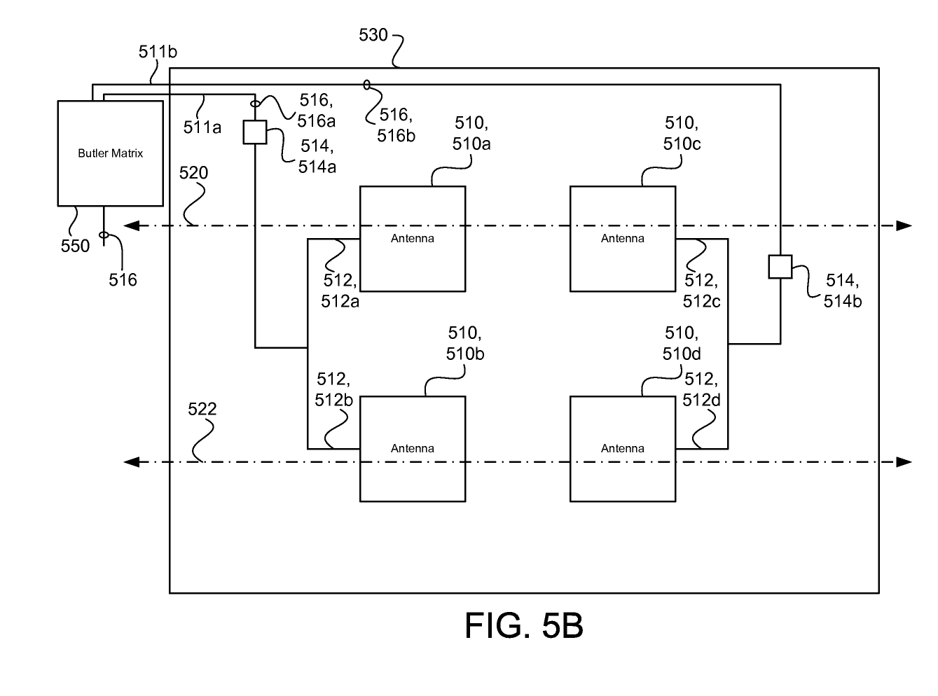

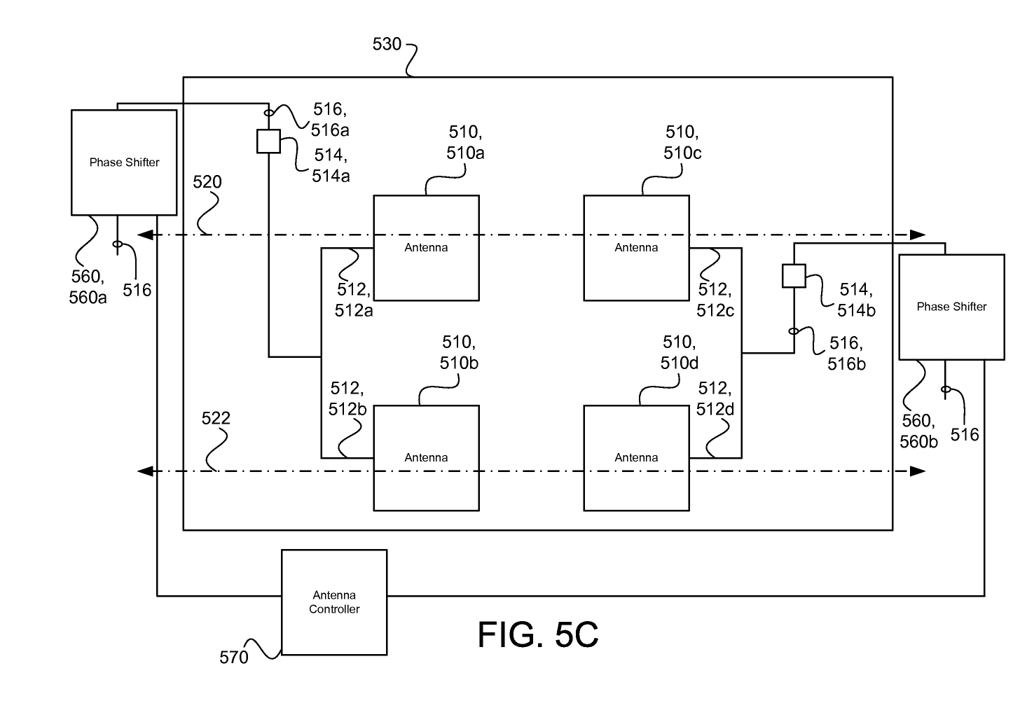

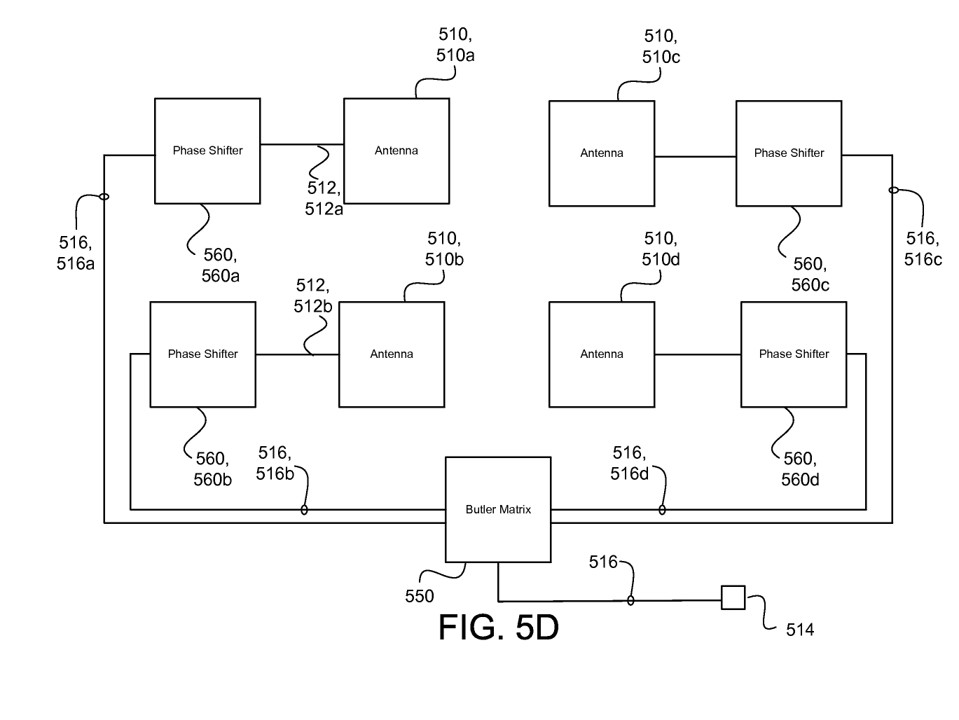

FIG. 5A provides a top view of an exemplary architecture of the antenna array 500. Four antennas 510, 510a . . . 510d are mounted on a micro strip 530. The micro strip 530 is a type of electric transmission line consisting of electric strips separated from a ground plane by a substrate. The micro strip 530 may be used to form transmission lines or antennas 510. Each antenna 510 has an orientation that may indicate and/or correspond to a beam orientation of the antenna 510 or an orientation of a beam forming pattern thereof. The orientation of the antenna 510 may be used for steering a corresponding emission beam 540 or as a reference direction for steering the corresponding emission beam 540. In some implementations, a first antenna 510a and third antenna 510c are orientated along a first axis 520, which substantially bisects the first antenna 510a and third antenna 510c. A second axis 522 is parallel to the first axis 520. A second antenna 510b and fourth antenna 510d may be oriented on the second axis 522. In at least one example, the first antenna 510a, second antenna 510b, third antenna 510c and fourth antenna 510d form a grid. The first antenna 510a and second antenna 510b may be oriented in a first direction along parallel to the first axis 520 and second axis 522. The third antenna 510c and fourth antenna 510d may be oriented in a second direction opposite the first direction and substantially parallel to the first axis 520 and second axis 522.

Electromagnetic energy or radio signals may be fed to each antenna 510, 510a . . . 510d by the use of a feed line 512. The first feed line 512a connects to the first antenna 510a and is oriented along the first axis 520. The second feed line 512b connects to the second antenna 510b and is oriented along the second axis 522. The third feed line 512c connects to the third antenna 510c and is oriented along the first axis 520. The fourth feed line 512d connects to the fourth antenna 510d and is oriented along the second axis 522. The orientation and length of the feed lines 512, 512a . . . 512d may contribute to the beam forming potential of the emission beam 540. An input port 514 provides a location for an electromagnetic signal 516 to be fed to the feed lines 512 and plurality of antennas 510. In at least one example, the first feed line 512a and second feed line 512b are connected to a first input port 514a. Both the first antenna 510a and the second antenna 510b are emitting a common electromagnetic signal 516 that is being input to the first input port 514a.

The phase of an electromagnetic signal 516 or radio wave may be dependent on the timing of the electromagnetic signal 516. The phase of a sinusoidal wave or electromagnetic signal 516 can be expressed as the fraction of the wave that has passed an arbitrary origin. When two or more electromagnetic signals 516 combine, the further the difference in the phase of the two signals, the greater the cancellation of the signals up to the point of complete cancellation. Complete cancellation occurs when the two electromagnetic signals 516 are exactly 180 degrees out of phase with each other. Partial cancellation of an electromagnetic signal 516 from phase difference may be used to create an emission beam 540 when using multiple antennas 510. The alteration of the phase of each electromagnetic signal 516 can be used to steer the emission beam 540 by altering the amount of phase cancellation occurring on the sides of the emission beam 540. The distance the electromagnetic signal 516 travels from the input port 514 along the feed line 512 to the antenna 510 can determine its phase. In at least one example, the distance the electromagnetic signal 516 travels from the first input port 514a along the first feed line 512a to the first antenna 510a is different than the distance the electromagnetic signal 516 travels from the second input port 514b along the third feed line 512c to the third antenna 510c resulting in a phase shift of the signal to each respective antenna 510. This phase shift of the electromagnetic signal 516 may help in forming the emission beam 540.

FIG. 5B provides a schematic view of an exemplary architecture of the antenna array 500 including a butler matrix 550. A first array feed line 511a connects the butler matrix 550 to the first input port 514a, thus connecting the butler matrix 550 to the first antenna 510a and the second antenna 510a. A second array feed line 511b connects the butler matrix 550 to the second input port 514b, thus connecting the butler matrix 550 to the third antenna 510c and the fourth antenna 510d. The electromagnetic signal 516 enters the butler matrix 550. In this example, two signals will be phase shifted, but by no means should it be interpreted to limit the number of electromagnetic signals 516 that may be phase shifted. The butler matrix 550 takes the electromagnetic signal 516 and divides it into a first electromagnetic signal 516a and a second electromagnetic signal 516b. The first electromagnetic signal 516a is phase sifted to a different phase than the second electromagnetic signal 516b. The first electromagnetic signal 516a, travels to the first input port 514a, the first feed line 512a and to the first antenna 510a and third antenna 510c. The first antenna 510a and third antenna 510c each emit the phase shifted first electromagnetic signal 516a. The second electromagnetic signal 516b, travels to the second input port 514b, the second feed line 512b and to the second antenna 510b and fourth antenna 510d. The second antenna 510b and fourth antenna 510d each emit the phase shifted second electromagnetic signal 516b. The emission of the phase shifted first electromagnetic signal 516a, and second electromagnetic signal 516b by the antennas 510 serve to emit an emission beam 540. The use of the butler matrix 550 is advantageous as it is a passive element requiring minimal power to operate and reduces the overall antenna array's 500 power requirements. Additionally, the butler matrix 550 has a fixed calibration and does not require re-calibration or adjustment as more traditional phase shifted antenna arrays.

FIG. 5C provides a schematic view of an exemplary architecture of the antenna array 500 including a phase shifter 560. In this example, two signals will be phase shifted but by no means should it be interpreted to limit the number of electromagnetic signals 516 that may be phase shifted. The electromagnetic signal 516 enters the phase shifter 560. The phase shifter 560 is a controllable and active device. The phase shifter 560 may actively adjust the phase of the electromagnetic signal 516. In at least one example, an electromagnetic signal 516 enters a first phase shifter 560a. The first phase shifter 560a is directed by an antenna controller 570. The antenna controller 570 directs the amount of phase shift the first phase shifter 560a should impart on the first electromagnetic signal 516a. The phase shifted first electromagnetic signal 516a then travels along the first input port 514a, first feed line 512a to the first antenna 510a and third antenna 510c. The electromagnetic signal 516 enters the second phase shifter 560b. The antenna controller 570 directs the second phase shifter 560b to phase shift the second electromagnetic signal 516b. The amount of phase shift of the second electromagnetic signal 516b may be the same or different than the amount of phase shift applied to the first electromagnetic signal 516a. The phase shifted second electromagnetic signal 516b then travels through the second input port 514b, the second feed line 512b to the second antenna 510b and fourth antenna 510d. Depending on the difference between the phase of the first electromagnetic signal 516a and second electromagnetic signal 516b, the emission beam 540 may be formed using the antennas 510. Additionally, variation in the phase of the first electromagnetic signal 516a and second electromagnetic signal 516b may allow the emission beam 540 to be steered or directed.

FIG. 5D provides a schematic view of an exemplary architecture of the antenna array 500 including a butler matrix 550 and phase shifter 560. In this example, four electromagnetic signals 516 and antennas 510 are used for simplicity, but this is not intended in any way to limit the number of electromagnetic signals 516 and antennas 510 this system can be used on. The electromagnetic signal 516 enters at the input port 514 and travels to the butler matrix 550. The butler matrix 550 splits the electromagnetic signal 516 into a first electromagnetic signal 516a, a second electromagnetic signal 516b, a third electromagnetic signal 516c, and a fourth electromagnetic signal 516d. The butler matrix 550 phase shifts each of the first electromagnetic signal 516a, the second electromagnetic signal 516b, the third electromagnetic signal 516c, and the fourth electromagnetic signal 516d to be given a different phase. The different phase between the first electromagnetic signal 516a, the second electromagnetic signal 516b, the third electromagnetic signal 516c, and the fourth electromagnetic signal 516d serve to create a passive emission beam 540. The emission beam is then made steerable by the further adjustment of the individual phase of the first electromagnetic signal 516a, the second electromagnetic signal 516b, the third electromagnetic signal 516c, and/or the fourth electromagnetic signal 516d by the respective phase shifter 560. In at least one example, the first electromagnetic signal 516a travels from the butler matrix 550 to a first phase shifter 560a and the first electromagnetic signal 516a is further phase shifted by the first phase shifter 560a. From the first phase shifter 560a, the first electromagnetic signal 516a travels to the first antenna 510, which emits the first electromagnetic signal 516a. The second electromagnetic signal 516b travels from the butler matrix 550 to a second phase shifter 560b, which further phase shifts the second electromagnetic signal 516b. From the second phase shifter 560b, the second electromagnetic signal 516b travels to the second antenna 510, which emits the second electromagnetic signal 516b. The third electromagnetic signal 516c travels to a third phase shifter 560c and the third phase shifter 560c shifts the phase of the third electromagnetic signal 516c. The third electromagnetic signal 516c then travels to the third antenna 510c, which emits third electromagnetic signal 516c. The fourth electromagnetic signal 516d travels to a fourth phase shifter 560d and the fourth phase shifter 560d shifts the phase of the fourth electromagnetic signal 516d. The fourth electromagnetic signal 516d travels to the fourth antenna 510d, which emits the fourth electromagnetic signal 516d. The emission from the first antenna 510a, the second antenna 510b, the third antenna 510c, and fourth antenna 510d serve to create the emission beam 540. The various phase shifts imparted by the first phase shifter 560a, the second phase shifter 560b, the third phase shifter 560c, and the fourth phase shifter 560d serve to alter the direction of the emission beam 540 allowing the emission beam to be steered.

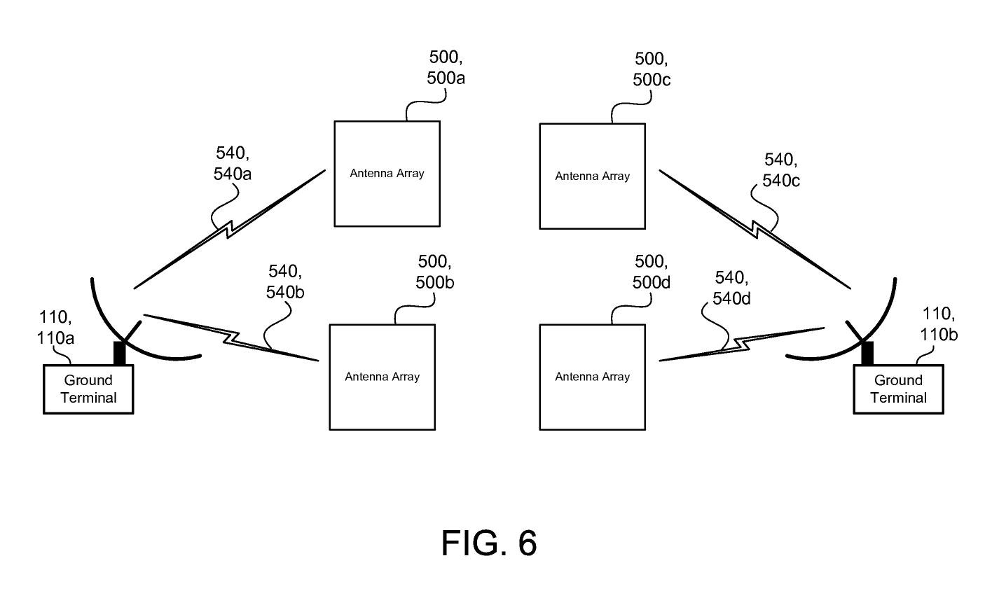

FIG. 6 provides a schematic view of an exemplary architecture of multiple antenna arrays 500, 500a . . . 500d with individual emission beams 540, 540a . . . 540d. Multiple antenna arrays 500 may be mounted in a grid pattern. The mounting pattern of the antenna arrays 500 may be mounted in any suitable pattern, such as, but not limited to, circular, clusters, round, rectangular, etc. The first antenna array 500a emits a first emission beam 540a. The second antenna array 500b emits a second emission beam 540b. The third antenna array 500c emits a third emission beam 540c. The fourth antenna array 500d emits a fourth emission beam 540d. Depending on the demand of the system or the reception required by the system, the antenna array 500 communicating with the individual emission beams 540 may be combined to form a stronger link, for example, if there are two ground terminals 110, 110a . . . 110b on the ground receiving communications from the HAP 200. While the HAP 200 is in close range, the first antenna array 500a may have sufficient power to remain in communication with the first ground terminal 110a through the first emission beam 540a and the third antenna array 500c may have sufficient power to remain in communication with the second ground terminal 110b through the second emission beam 540b. This may be advantageous as a single emission beam 540 uses less power than multiple emission beams 540. As the HAP 200 increases in distance from the ground terminal 110 or interference becomes present, communication with the first ground terminal 110a and second ground terminal 110b may degrade. To improve the communications range and or resistance to interference, the second antenna array 500b may steer the second emission beam 540b to the first ground terminal 110a to improve communication. The fourth antenna array 500d may also steer the fourth emission beam 540d to the second ground terminal 110b to improve communication. In the event communication continues to degrade, the first emission beam 540a, second emission beam 540b and third emission beam 540c may all be directed to the first ground station 100a by their respective antenna arrays 500 to improve communication or signal strength. The emission beams 540 may also be combined in response to the data volume that is being transmitted with more emission beams 540 giving a greater data volume. There is no limit to the number of emission beams 540 that may be created or merged to improve communications.

The emission beam 540 of each antenna 510 may be steered (e.g., rotated, angled, translated, or otherwise moved) to achieve a desired result. Moreover, by controlling the beam former (e.g., the butler matrix 550) and the antenna array 500 separately from each other, the antenna controller 570 may steer individual beams 540 and/or all beams 540 at the same time, thus providing a multi-active beam phased array antenna system. The antenna controller 570 may move beams 540 to fill gaps or holes in coverage, to overlap coverage of other beams 540, and/or to move away from interference. In general, an antenna may need good directivity for transmitting and receiving data reliably. A narrow beam concentrates energy to a small region, which is more power efficient. In some examples, each antenna 510 can generate multiple narrow beams 540 (e.g., multiple beams from a single aperture) and the antenna controller 570 can steer each beam 540 individually and/or as a collection of beams 540.

A number of implementations have been described. Nevertheless, it will be understood that various modifications may be made without departing from the spirit and scope of the disclosure. Accordingly, other implementations are within the scope of the following claims.

What is claimed is:

1. An antenna array comprising:
a first antenna disposed on a micro strip and oriented along a first axis in a first direction;
a second antenna disposed on the micro strip and oriented along a second axis in the first direction;
a third antenna disposed on the micro strip and oriented along the first axis in a second direction opposite the first direction;
a fourth antenna disposed on the micro strip and oriented along the second axis in the second direction; and
a phase shifter connected to at least one of the antennas.

2. The antenna array of claim 1, further comprising:
a first feed line connected to the first antenna oriented on the first axis in the first direction; and
a second feed line connected to the second antenna oriented on the second axis in the first direction.

3. The antenna array of claim 2, further comprising:
a third feed line connected to the third antenna oriented on the first axis in the second direction; and
a fourth feed line connected to the fourth antenna oriented on the second axis in the second direction.

4. The antenna array of claim 3, further comprising:
a first array feed line connected to the first feed line and the second feed line; and
a second array feed line connected to the third feed line and the fourth feed line.

5. The antenna array of claim 4, wherein the first antenna, the second antenna, the third antenna, and the fourth antenna transmit a steerable beam.

6. The antenna array of claim 5, further comprising a butler matrix connected to the first antenna, the second antenna, the third antenna, and the fourth antenna.

7. The antenna array of claim 5, wherein the steerable beam is steerable by varying a power to the first array feed line and the second array feed line.

8. The antenna array of claim 7, further comprising a butler matrix connected to the phase shifter to provide a beam forming network.

9. The antenna array of claim 5, further comprising:
a first input port connected to the first feed line;
a second input port connected to the second feed line;
a first signal length related to a distance a signal must travel from the first input port to the first antenna; and
a second signal length related to the distance the signal must travel from the second input port to the third antenna,
wherein the first signal length and second signal length are different lengths.

10. The antenna array of claim 9, wherein the beam is steerable by adjusting the phase shifter to steer the steerable beam.

11. The antenna array of claim 10, wherein the steerable beam transmits and/or receives data.

12. A communication system comprising:
an unmanned aerial system;
at least one antenna array disposed on the unmanned aerial system, the at least one antenna array comprising:
a first antenna disposed on a micro strip and configured to transmit a first signal;
a second antenna disposed on the micro strip and configured to transmit a second signal;
a third antenna disposed on the micro strip and configured to transmit a third signal;
a fourth antenna disposed on the micro strip and configured to transmit a fourth signal; and
a phase shifter connected to at least one of the antennas;
wherein the first signal, second signal, third signal, and fourth signal combine to form a steerable beam; and
a ground station configured to communicate with the at least one antenna array.

13. The communication system of claim 12, wherein the unmanned aerial system steers the steerable beam based on a position of the unmanned aerial system in relation to the ground station.

14. The communication system of claim 12, wherein at least one antenna array comprises:
a first antenna array having a first steerable beam; and
a second antenna array having a second steerable beam, wherein the second steerable beam combines with the first steerable beam to form a third steerable beam.

15. The communication system of claim 14, wherein the second steerable beam combines with the first steerable beam to form the third steerable beam in response to a data volume being communicated by the ground station.

16. The communication system of claim 14, wherein the second steerable beam combines with the first steerable beam to form the third steerable beam in response to a signal strength received by the first antenna array and the second antenna array.

17. The communication system of claim 14, wherein the third steerable beam communicates data to the ground station.

18. The communication system of claim 14, wherein the second steerable beam communicates data to a first ground station and the third steerable beam communicates data to a second ground station.

19. The communication system of claim 14, wherein the second steerable beam communicates data to a user device.

20. The communication system of claim 12, wherein:
the first antenna is disposed on a micro strip and oriented along a first axis in a first direction;
the second antenna is disposed on the micro strip and oriented along a second axis in the first direction;
the third antenna is disposed on the micro strip and oriented along the first axis in a second direction opposite the first direction; and
the fourth antenna is disposed on the micro strip and oriented along the second axis in the second direction.

21. The communication system of claim 20, wherein the antenna array further comprises:
a first feed line connected to the first antenna oriented on the first axis in the first direction; and
a second feed line connected to the second antenna oriented on the second axis in the first direction.

22. The communication system of claim 21, wherein the antenna array further comprises:
a third feed line connected to the third antenna oriented on the first axis in the second direction; and
a fourth feed line connected to the fourth antenna oriented on the second axis in the second direction.

23. The communication system of claim 22, wherein the antenna array further comprises:
a first array feed line connected to the first feed line and the second feed line; and
a second array feed line connected to the third feed line and the fourth feed line.
